(19) United States
(12) Patent Application Publication
(10) Pub. No.: US 2022/0300346 A1
(43) Pub. Date: Sep. 22, 2022

(54) INFORMATION PROCESSING DEVICE AND METHOD OF SCHEDULING

(71) Applicant: FUJITSU LIMITED, Kawasaki-shi (JP)

(72) Inventor: Akira HIRAI, Kawasaki (JP)

(73) Assignee: FUJITSU LIMITED, Kawasaki-shi (JP)

(21) Appl. No.: 17/580,979

(22) Filed: Jan. 21, 2022

(30) Foreign Application Priority Data
Mar. 18, 2021 (JP) 2021-044366

(51) Int. Cl. G06F 9/50

(52) U.S. Cl. CPC G06F 9/5094

(57) ABSTRACT

An information processing device includes a memory, and a processor coupled to the memory and the processor configured to measure energy consumption of a first unit of processing that operates in the processor, stop an operation of the first unit of processing when the measured energy consumption reaches a predetermined value, and operate a second unit of processing in the processor.

### CROSS-REFERENCE TO RELATED APPLICATION

This application is based upon and claims the benefit of priority of the prior Japanese Patent Application No. 2021-44366, filed on Mar. 18, 2021, the entire contents of which are incorporated herein by reference.

### FIELD

The embodiment discussed herein is related to a scheduling technique.

### BACKGROUND

In recent years, the importance of power efficiency in information and communication technology (ICT) systems has been heightened. Along with this, various efforts are being made to improve power efficiency regardless of the scale of information processing devices, from mobile terminal devices typified by smartphones to high-end servers. The information processing device is sometimes called a computer.

The power consumption of the central processing unit (CPU) accounts for the largest proportion of the power consumption of the information processing device, and controlling the power consumption of the CPU is especially important to improve the power efficiency of the information processing device.

For example, existing operating systems (OSs) such as Linux (registered trademark) and Windows (registered trademark) employ time-division and preemptive multitasking schedulers. The time-division scheduler switches processes on the basis of a time slice, which is the executable time for each process. The executable time is sometimes called the executable period.

In the preemptive multitasking approach, in order to switch a process being executed to another process at a time point when the time slice has elapsed, the OS uses an interrupt mechanism to suspend processing of the process currently being executed by a timer interrupt or a clock interrupt. The OS then calls the scheduler to cause the scheduler to determine the next process to execute.

In relation to scheduling, a job management device that creates a job schedule based on the total amount of power consumption has been known. A scheduling method for extending the operating life of a battery in a battery-powered electronic computer has also been known. A technique that reduces the amount of consumed power of a processing integrated circuit has also been known.

A high-performance CPU for a post-“K” computer has also been known.

Japanese Laid-open Patent Publication No. 2016-71841, Japanese Laid-open Patent Publication No. 7-168726, and Japanese National Publication of International Patent Application No. 2005-527010 are disclosed as related art.

Toshio Yoshida, “Fujitsu High Performance CPU for the Post-K Computer”, [online], Aug. 28, 2018, The Society of Scientific Systems, [search was made on February 19, Third Year of Reiwa], Internet <URL: http://www.ssken.grjp/MAINSITE/event/2018/20180828-hpcf/lecture-05/SSKEN_hpcf2018_YoshidaToshio.pdf> is also disclosed as related art.

### SUMMARY

According to an aspect of the embodiment, an information processing device includes a memory, and a processor coupled to the memory and the processor configured to measure energy consumption of a first unit of processing that operates in the processor, stop an operation of the first unit of processing when the measured energy consumption reaches a predetermined value, and operate a second unit of processing in the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional configuration diagram of a computer;

FIG. 2 is a flowchart of scheduling processing;

FIG. 3 is a configuration diagram of a first computer;

FIG. 4 is a functional configuration diagram of an arithmetic processing unit of the first computer;

FIG. 5 is a diagram illustrating a management table of the first computer;

FIGS. 6A to 6C are diagrams illustrating first update processing;

FIGS. 7A and 7B are diagrams illustrating second update processing;

FIG. 8 is a flowchart of first scheduling processing;

FIG. 9 is a configuration diagram of a second computer;

FIG. 10 is a functional configuration diagram of an arithmetic processing unit of the second computer;

FIG. 11 is a diagram illustrating a management table of the second computer;

FIGS. 12A to 12C are diagrams illustrating third update processing;

FIGS. 13A to 13D are diagrams illustrating fourth update processing;

FIG. 14A is a flowchart (part 1) of second scheduling processing;

FIG. 14B is a flowchart (part 2) of second scheduling processing; and

FIG. 15 is a hardware configuration diagram of an information processing device.

### DESCRIPTION OF EMBODIMENT

In the preceding time-division and preemptive multitasking scheduling described above, the CPU time is distributed to processes on the basis of the execution time of the processes. However, in scheduling, energy consumption, which is the power consumed by each process, is not taken into consideration.

Note that such a problem rises not only in computers that employ the time-division and preemptive multitasking scheduling but also in computers that employ various scheduling approaches. Furthermore, such a problem rises not only in the scheduling of processes but also in the scheduling of various units of processing.

Hereinafter, an embodiment will be described in detail with reference to the drawings.

In a preceding computer, a power consumption measuring instrument called a power monitor chip is mounted on a main board, and the power consumption measuring instrument measures the power consumption of the entire main board. Some CPUs are equipped with a mechanism that monitors and controls the power consumption of the CPU and memory, such as running average power limit (RAPL). The RAPL also measures the power consumption of the entire main board or the entire CPU package (in units of sockets).

Usually, latest computers include multi-core and multi-socket CPUs, and the operating frequency is different for each CPU core. In a computer in which a plurality of processes or jobs are executed in parallel at different operating frequencies, it is difficult to estimate the energy consumption of each CPU core and processes operating in these CPU cores and perform scheduling based on the energy consumption.

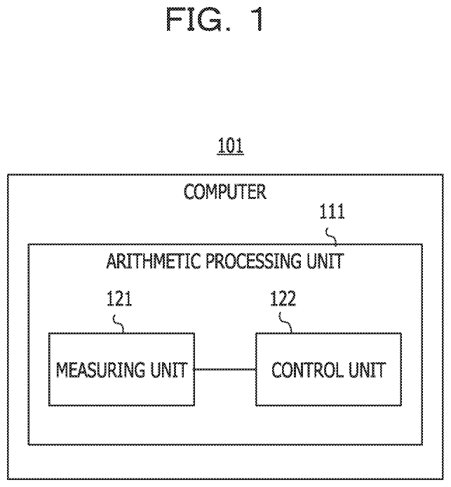

FIG. 1 illustrates an exemplary functional configuration of a computer according to the embodiment. The computer 101 in FIG. 1 includes an arithmetic processing unit 111, and the arithmetic processing unit 111 includes a measuring unit 121 and a control unit 122.

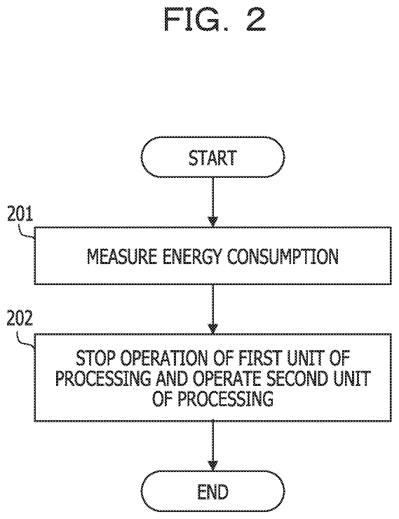

FIG. 2 is a flowchart illustrating an example of scheduling processing performed by the computer 101 in FIG. 1. First, the control unit 122 causes the measuring unit 121 to measure the energy consumption of a first unit of processing that operates in the arithmetic processing unit 111 (step 201). Then, when the energy consumption measured by the measuring unit 121 reaches a predetermined value, the control unit 122 stops the operation of the first unit of processing and operates a second unit of processing in the arithmetic processing unit (step 202).

According to the computer 101 in FIG. 1, scheduling may be performed based on the energy consumption of the unit of processing.

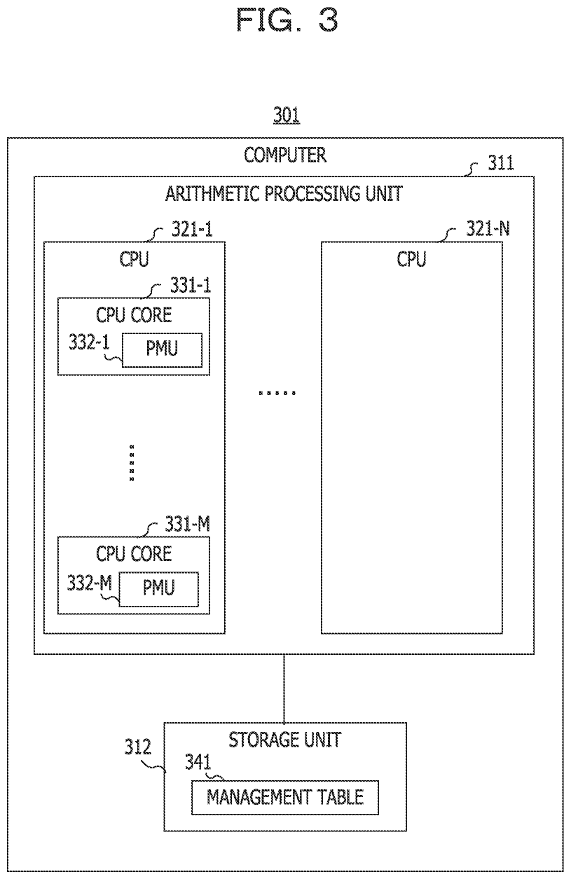

FIG. 3 illustrates an exemplary configuration of a first computer corresponding to the computer 101 in FIG. 1. The computer 301 in FIG. 3 includes an arithmetic processing unit 311 and a storage unit 312. The arithmetic processing unit 311 includes CPUs 321-1 to 321-N (N is an integer equal to or greater than one). The respective CPUs 321-i (i=1 to N) include CPU cores 331-1 to 331-M (M is an integer equal to or greater than one), and each CPU core 331-j (j=1 to M) includes a performance monitoring unit (PMU) 332-j.

The arithmetic processing unit 311, the storage unit 312, the CPU 321-i, the CPU core 331-j, and the PMU 332-j are hardware. The PMU 332-j is, for example, a measuring circuit that measures the energy consumption. The arithmetic processing unit 311 and the PMU 332-j correspond to the arithmetic processing unit 111 and the measuring unit 121 in FIG. 1, respectively.

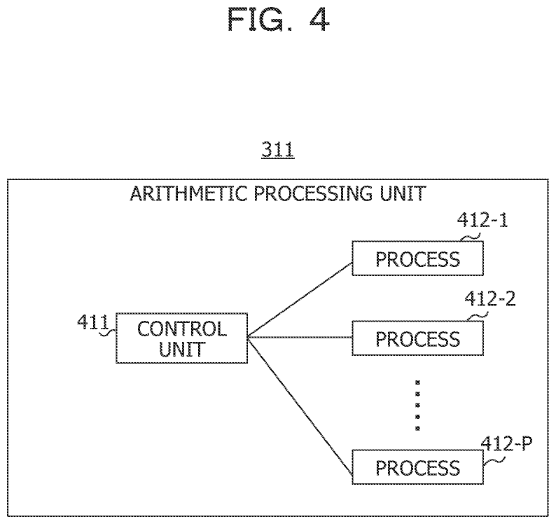

FIG. 4 illustrates an exemplary functional configuration of the arithmetic processing unit 311 in FIG. 3. The arithmetic processing unit 311 in FIG. 4 includes a control unit 411 and processes 412-1 to 412-P (P is an integer equal to or greater than two). Each process 412-k (k=1 to P) is generated when any CPU core 331-j of any CPU 321-i executes an application program. The process 412-k is an example of a unit of processing.

Any CPU core 331-j of any CPU 321-i also operates as the control unit 411 by executing a scheduler included in a program such as an operating system or job management software. The control unit 411 corresponds to the control unit 122 in FIG. 1.

The storage unit 312 stores a management table 341. The management table 341 contains the remaining amount of consumable energy allocated to each of the processes 412-1 to 412-P. The consumable energy of the process 412-k represents the energy consumption that the process 412-k is allowed to use. The consumable energy may have a fixed value that does not depend on the process 412-k or may have a value that increases as the process 412-k has a higher priority.

The PMU 332-j measures the energy consumption of the process 412-k operating in the CPU core 331-j. The energy consumption of the process 412-k is, for example, power consumed by the CPU core 331-j executing the process 412-k.

The PMU 332-j measures the integrated energy consumption value for each CPU core 331-j as a measurement event of a performance monitoring counter. Furthermore, the PMU 332-j has a function of causing an interrupt when a counter overflow occurs or when an arbitrary number of events are counted.

As the PMU 332-j, for example, Energy Analyzer may be used. The Energy Analyzer implements an energy consumption counting function for each CPU core and each CPU cycle, as a measurement event of the performance monitoring counter. In addition, the Energy Analyzer has a function of causing an interrupt when an initial value is set in the counter and when a counter overflow occurs.

The control unit 411 performs process scheduling while referring to the management table 341. The control unit 411 sets the remaining amount of the consumable energy of each process 412-k recorded in the management table 341 in the PMU 332-j in the CPU core 331-j in which the relevant process 412-k is operating.

The PMU 332-j uses the set remaining amount of the consumable energy as a predetermined value. When the integrated value of the measured energy consumption of the process 412-k reaches the remaining amount of the consumable energy of the process 412-k, the PMU 332-j outputs an interrupt signal indicating that the remaining amount of the consumable energy has been reached, to the control unit 411. The interrupt signal indicating that the remaining amount of the consumable energy has been reached is an example of interrupt information.

When the interrupt signal is output from the PMU 332-j, the control unit 411 switches the process 412-k in the CPU core 331-j to another process 412-m (m≠k).

At this time, the control unit 411 changes the remaining amount of the consumable energy of the process 412-k recorded in the management table 341 to zero and selects the process 412-m based on the remaining amount of the consumable energy of each of the processes 412-1 to 412-P. Then, the control unit 411 stops the operation of the process 412-k and allocates the process 412-m to the CPU core 331-j to operate the process 412-m in the CPU core 331-j.

This allows the processing of the process 412-k, which has run out of the remaining amount of the consumable energy, to be forcibly suspended and another process 412-m having the remaining amount of the consumable energy to use the CPU core 331-j. At this time, by selecting the process 412-m based on the remaining amount of the consumable energy, for example, the process 412-m with a large remaining amount of the consumable energy may be preferentially caused to use the CPU core 331-j.

When any process 412-k temporarily terminates processing due to abandoned processing, the control unit 411 acquires information regarding the energy consumption of the process 412-k from the PMU 332-j in the CPU core 331-j in which the process 412-k is operating. For example, the abandoned processing occurs by accessing an auxiliary storage device (input/output processing), accessing a communication network, or the like. The information regarding the energy consumption is, for example, a counter value indicating the integrated value of the energy consumption.

The control unit 411 reduces the remaining amount of the consumable energy of the process 412-k recorded in the management table 341 based on the acquired information and switches the process 412-k in the CPU core 331-j to another process 412-m.

At this time, the control unit 411 selects the process 412-m based on the remaining amount of the consumable energy of each of the processes 412-1 to 412-P. Then, the control unit 411 stops the operation of the process 412-k and allocates the process 412-m to the CPU core 331-j to operate the process 412-m in the CPU core 331-j.

This allows the process 412-k, which no longer needs to continue processing, to be stopped and another process 412-m having the remaining amount of the consumable energy to use the CPU core 331-j. At this time, by selecting the process 412-m based on the remaining amount of the consumable energy, for example, the process 412-m with a large remaining amount of the consumable energy may be preferentially caused to use the CPU core 331-j.

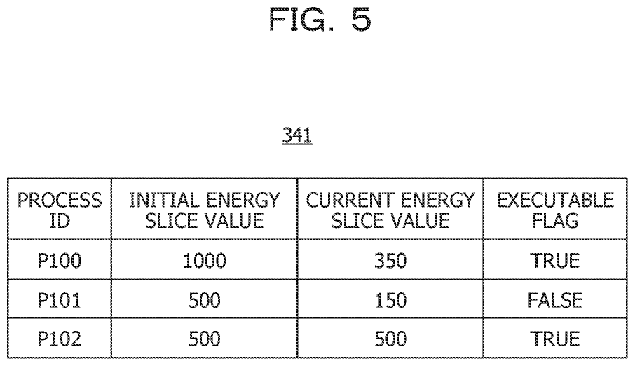

FIG. 5 illustrates an example of the management table 341 in FIG. 3. The management table 341 in FIG. 5 contains a process identifier (ID), an initial energy slice value, a current energy slice value, and an executable flag.

The process ID is identification information of the process 412-k. The initial energy slice value represents the consumable energy allocated to the process 412-k, and the current energy slice value represents the remaining amount of the consumable energy. The units of the initial energy slice value and the current energy slice value are nanojoule (nJ). The initial energy slice value and the current energy slice value are examples of the predetermined value.

The executable flag indicates the value of either of TRUE or FALSE. TRUE represents that the process 412-k is executable, and FALSE represents that the process 412-k is inexecutable. In the following, a process X will be sometimes used to mean the process 412-k whose process ID is X.

For example, a process P100 has an initial energy slice value of 1000 nJ, a current energy slice value of 350 nJ, and an executable flag of TRUE. In this case, 650 nJ, which is the difference between the initial energy slice value and the current energy slice value, has already been consumed by the process P100.

Each time the process 412-k is generated, the control unit 411 adds an entry of the generated process 412-k to the management table 341 and deletes the added entry when the process 412-k disappears. When the process 412-k is generated, the control unit 411 sets the consumable energy as the initial energy slice value and the current energy slice value and sets the executable flag to TRUE.

When allocating the process 412-k whose executable flag is TRUE to one CPU core 331-j, the control unit 411 sets a counter start value CTR0 as a counter value CTR of the PMU 332-j in the one CPU core 331-j, as in the following formula (1).

CTR0=CTRMAX−ES+1 (1)

In formula (1), CTRMAX represents the maximum countable value, and ES represents the current energy slice value. At the time when the process 412-k is generated, the current energy slice value matches the initial energy slice value. The units of CTR and CTRMAX are the same as the unit of ES.

The control unit 411 instructs the PMU 332-j to start counting, and the PMU 332-j starts counting from CTR0 and increments CTR by one each time the CPU core 331-j consumes one unit of energy consumption. Accordingly, CTR represents the sum of CTR0 and the integrated value of the energy consumption. CTR is an example of information regarding the energy consumption.

When the CPU core 331-j runs out of ES, CTR exceeds CTRMAX, causing a counter overflow. When a counter overflow occurs, the PMU 332-j outputs the interrupt signal to the control unit 411.

When the interrupt signal is output from the PMU 332-j, the control unit 411 changes the current energy slice value of the process 412-k recorded in the management table 341 to 0 nJ. Then, the control unit 411 selects the process 412-m having the maximum current energy slice value from among the processes 412-k whose executable flag is TRUE and switches the process 412-k that has run out of ES to the selected process 412-m.

By changing the current energy slice value of the process 412-k to 0 nJ, this process 412-k may be restricted from being selected as the process 412-m.

Note that, when the current energy slice values of all processes 412-k whose executable flag is TRUE are 0 nJ, the control unit 411 changes the current energy slice values of these processes 412-k to the initial energy slice values. Then, the control unit 411 selects the process 412-m having the maximum current energy slice value from among these processes 412-k.

When the process 412-k is switched due to abandoned processing before the process 412-k runs out of ES, the control unit 411 acquires CTR of the process 412-k from the PMU 332-j and calculates updated ES by the following formula (2).

ES=CTRMAX−CTR+1 (2)

Since acquired CTR is greater than the result of subtracting the initial energy slice value from CTRMAX+1, ES in formula (2) has a smaller value than the initial energy slice value. The control unit 411 reduces the current energy slice value by changing the current energy slice value of the process 412-k recorded in the management table 341 to updated ES. The difference between the initial energy slice value and updated ES denotes energy consumed by the process 412-k out of the consumable energy.

Next, the control unit 411 changes the executable flag of the process 412-k recorded in the management table 341 from TRUE to FALSE. Then, the control unit 411 selects another process 412-m in a manner similar to when the interrupt signal is output and switches the process 412-k in which abandoned processing has occurred to the process 412-m.

Thereafter, when process state monitoring processing of the OS detects that the state of the process 412-k has shifted to the executable state, the control unit 411 changes the executable flag of that process 412-k from FALSE to TRUE. For example, when access to the auxiliary storage device, access to the communication network, or the like is completed, the state of the process 412-k shifts to the executable state.

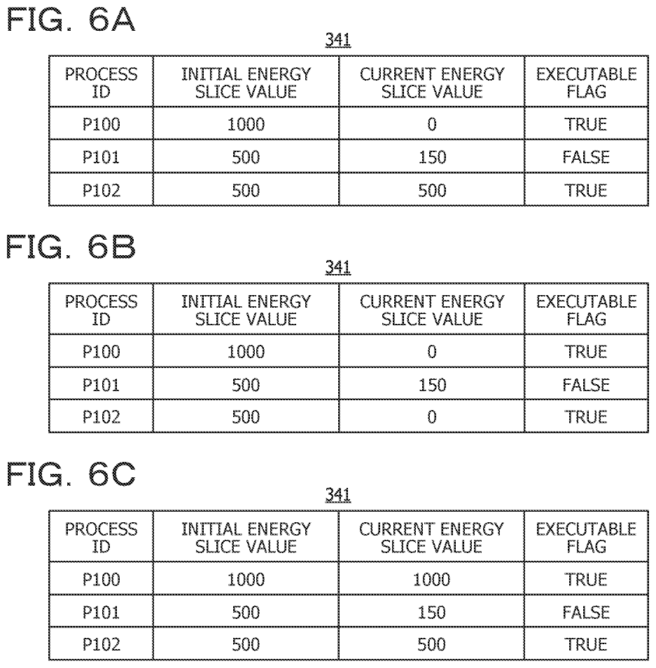

FIGS. 6A to 6C illustrate examples of first update processing that updates the management table 341 when the interrupt signal is output from the PMU 332-1 in the CPU core 331-1 of the CPU 321-1. FIG. 6A illustrates an example of update processing when the CPU core 331-1 has run out of the current energy slice value of the process P100 while the process P100 in FIG. 5 is operating in the CPU core 331-1.

When the CPU core 331-1 has run out of the current energy slice value of the process P100 and an interrupt signal is output from the PMU 332-1, the current energy slice value of the process P100 is changed from 350 nJ to 0 nJ. Then, among the process P100 and a process P102 whose executable flag is TRUE, the process P102 having the maximum current energy slice value is selected, and the process P100 is switched to the process P102.

FIG. 6B illustrates an example of update processing when the CPU core 331-1 has run out of the current energy slice value of the process P102 while the process P102 in FIG. 6A is operating in the CPU core 331-1. When the CPU core 331-1 has run out of the current energy slice value of the process P102 and an interrupt signal is output from the PMU 332-1, the current energy slice value of the process P102 is changed from 500 nJ to 0 nJ.

FIG. 6C illustrates an example of update processing that updates the current energy slice values of the processes P100 and P102 in FIG. 6B. In FIG. 6B, the current energy slice values of the processes P100 and P102 whose executable flag is TRUE are both 0 nJ.

Therefore, the current energy slice value of the process P100 is changed to 1000 nJ, which is the initial energy slice value, and the current energy slice value of the process P102 is changed to 500 nJ, which is the initial energy slice value. Then, the process P100 having the maximum current energy slice value is selected, and the process P102 is switched to the process P100.

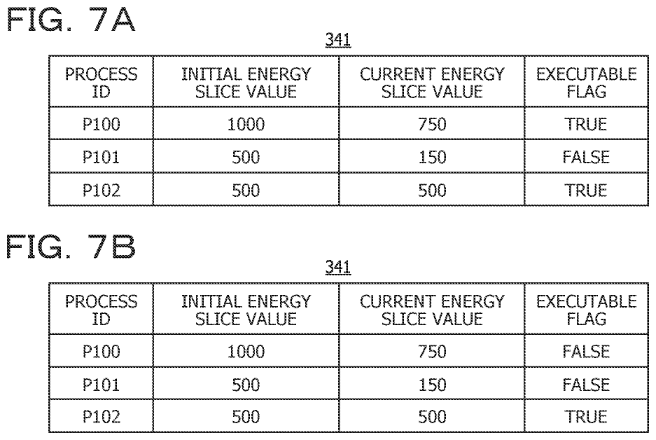

FIGS. 7A and 7B illustrate examples of second update processing that updates the management table 341 when abandoned processing occurs in the process 412-k. FIG. 7A illustrates an example of update processing when abandoned processing occurs in the process P100 while the process P100 in FIG. 6C is operating in the CPU core 331-1. In this case, the current energy slice value of the process P100 is updated by formula (2).

For example, in a case where the process P100 has consumed 250 nJ out of 1000 nJ and CTR=CTR0+250 holds when abandoned processing occurs, the updated current energy slice value is calculated by the following formula (3).

$$\begin{matrix}ES = CTRMAX - ( CTR 0 + 250 ) + 1 \\ = CTRMAX - ( CTRMAX - 100 + 1 + 250 ) + 1 \\ = 750\end{matrix} \qquad ( 3 )$$

FIG. 7B illustrates an example of update processing that updates the executable flag of the process P100 in FIG. 7A. When abandoned processing occurs in the process P100, the executable flag of the process P100 is changed from TRUE to FALSE. In this case, since only the executable flag of the process P102 is TRUE, the process P102 is selected, and the process P100 is switched to the process P102.

Note that the process 412-k whose executable flag is TRUE is not necessarily allocated to the CPU core 331-1 of the CPU 321-1, but any CPU core 331-j of any CPU 321-i has a possibility of being allocated.

According to the computer 301 in FIG. 3, the consumable energy is allocated to each process 412-k, and the process 412-k that has run out of the remaining amount of the consumable energy is switched to another process 412-m. This enables scheduling based on the energy consumption of the processes 412-k.

By setting, as the consumable energy, a value that increases as the process 412-k has a higher priority, the process 412-k with a higher priority may be preferentially caused to consume the power. This allows the power consumption of each CPU core 331-j to be flexibly controlled.

The computer 301 sometimes includes the multi-core and multi-socket CPU 321-i and executes a plurality of processes 412-k in parallel at different operating frequencies. Even in such a case, by providing the PMU 332-j in each CPU core 331-j, the energy consumption of each process 412-k may be measured accurately.

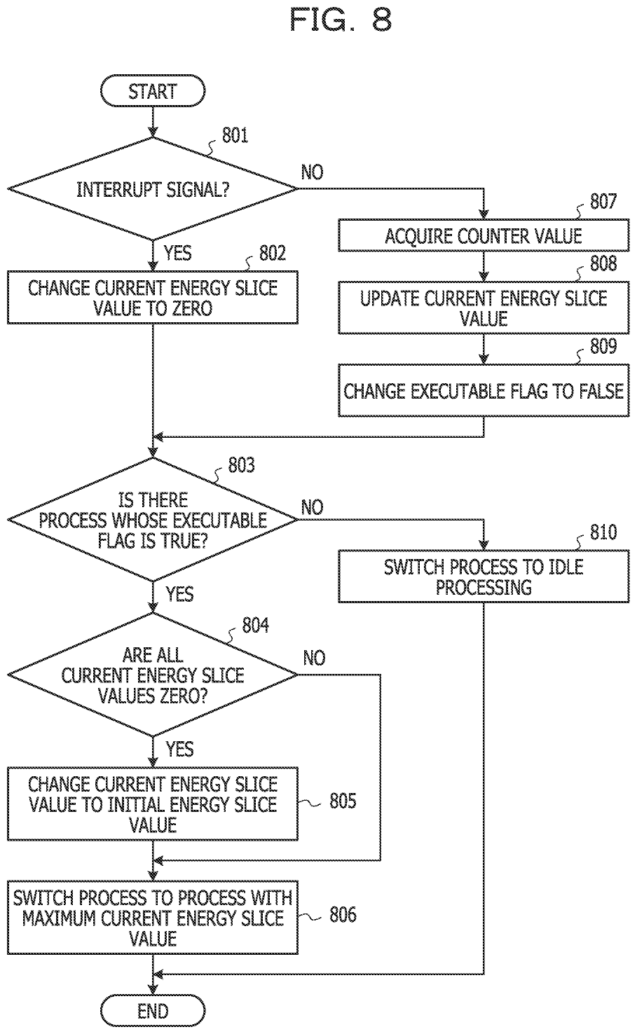

FIG. 8 is a flowchart illustrating an example of first scheduling processing performed by the computer 301 in FIG. 3. The scheduling processing in FIG. 8 is performed when the interrupt signal from the PMU 332-j or abandoned processing occurs while any process 412-k is operating in any CPU core 331-j of any CPU 321-i.

First, the control unit 411 checks which of the interrupt signal from the PMU 332-j and abandoned processing has occurred (step 801). When the interrupt signal from the PMU 332-j has occurred (step 801, YES), the control unit 411 changes the current energy slice value of the process 412-k recorded in the management table 341 to zero (step 802).

Next, the control unit 411 checks whether or not there is the process 412-k whose executable flag is TRUE in the management table 341 (step 803). When there is the process 412-k whose executable flag is TRUE (step 803, YES), the control unit 411 checks the current energy slice value of each process 412-k whose executable flag is TRUE (step 804).

When the current energy slice values of all processes 412-k whose executable flag is TRUE are zero (step 804, YES), the control unit 411 performs the processing in step 805. In step 805, the control unit 411 changes the current energy slice value of each process 412-k whose executable flag is TRUE to the particular initial energy slice value of each process 412-k.

Then, the control unit 411 selects the process 412-m having the maximum current energy slice value from among the processes 412-k whose executable flag is TRUE and switches the process 412-k that has been operating to the process 412-m (step 806).

When the current energy slice value of any process 412-k whose executable flag is TRUE is not zero (step 804, NO), the control unit 411 performs the processing in step 806.

When there is no process 412-k whose executable flag is TRUE in the management table 341 (step 803, NO), the control unit 411 switches the process 412-k that has been operating to idle processing (step 810). In the idle processing, processing for none of the processes 412-1 to 412-P is executed.

When abandoned processing has occurred in the process 412-k (step 801, NO), the control unit 411 acquires the counter value CTR of the process 412-k from the PMU 332-j in the CPU core 331-j in which the process 412-k is operating (step 807).

Next, the control unit 411 calculates ES by formula (2) and changes the current energy slice value of the process 412-k recorded in the management table 341 to ES to update the current energy slice value (step 808). Then, the control unit 411 changes the executable flag of the process 412-k recorded in the management table 341 from TRUE to FALSE (step 809) and performs the processing in step 803 and subsequent steps.

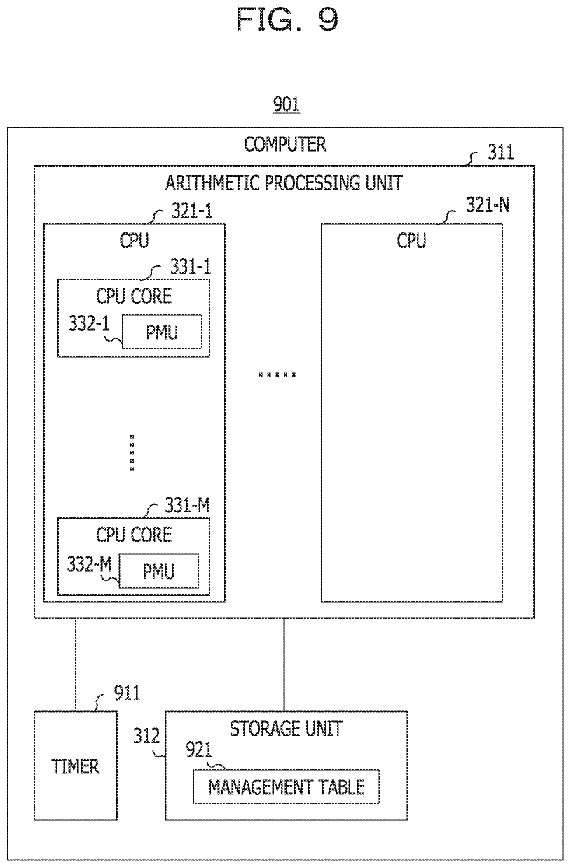

FIG. 9 illustrates an exemplary configuration of a second computer corresponding to the computer 101 in FIG. 1. The computer 901 in FIG. 9 has a configuration in which a timer 911 is added to the computer 301 in FIG. 3. The timer 911 is hardware and is, for example, a measuring circuit that measures time. The timer 911 counts time and outputs an interrupt signal at regular time intervals. The operation of a PMU 332-j in FIG. 9 is similar to the case in FIG. 3.

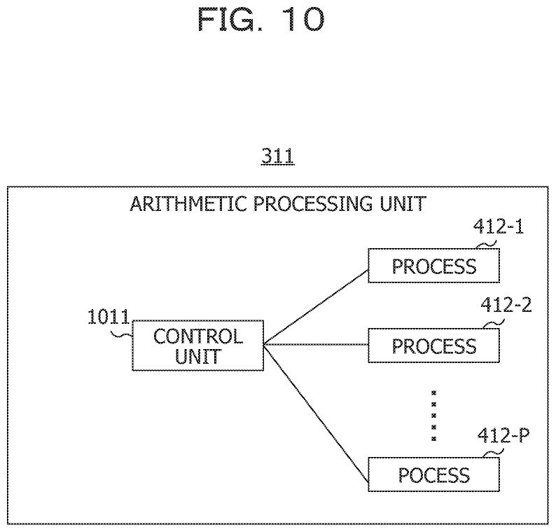

FIG. 10 illustrates an exemplary functional configuration of an arithmetic processing unit 311 in FIG. 9. The arithmetic processing unit 311 in FIG. 10 has a configuration in which the control unit 411 in FIG. 4 is replaced with a control unit 1011. Any CPU core 331-j of any CPU 321-i operates as the control unit 1011 by executing a scheduler included in a program such as an operating system or job management software. The control unit 1011 corresponds to the control unit 122 in FIG. 1.

A storage unit 312 stores a management table 921. The management table 921 contains the remaining amounts of executable time and consumable energy allocated to each of the processes 412-1 to 412-P. The executable time of the process 412-k represents time that the process 412-k is allowed to use. Similar to the consumable energy, the executable time may have a fixed value that does not depend on the process 412-k or may have a value that increases as the process 412-k has a higher priority.

The control unit 1011 performs process scheduling using the preceding time-division and preemptive multitasking scheduling and the scheduling based on the energy consumption in combination while referring to the management table 921. Then, when the process 412-k has run out of either the remaining amount of the consumable energy or the remaining amount of the executable time, the control unit 1011 switches this process 412-k to another process 412-m.

The control unit 1011 sets the remaining amount of the consumable energy of each process 412-k recorded in the management table 921 in the PMU 332-j in the CPU core 331-j in which the relevant process 412-k is operating.

The PMU 332-j outputs the interrupt signal to the control unit 1011 when the integrated value of the measured energy consumption of the process 412-k reaches the remaining amount of the consumable energy of the process 412-k.

Each time the interrupt signal is output from the timer 911, the control unit 1011 subtracts a certain amount of time from the remaining amount of the executable time of the process 412-k recorded in the management table 921 and checks whether or not the remaining amount of the executable time coincides with zero. When the remaining amount of the executable time coincides with zero, the control unit 1011 switches the process 412-k in the CPU core 331-j to another process 412-m.

At this time, the control unit 1011 changes the remaining amount of the consumable energy of the process 412-k recorded in the management table 921 to zero and selects the process 412-m based on the remaining amount of the executable time of each of the processes 412-1 to 412-P. Then, the control unit 1011 stops the operation of the process 412-k and allocates the process 412-m to the CPU core 331-j to operate the process 412-m in the CPU core 331-j.

This allows the processing of the process 412-k, which has run out of the remaining amount of the executable time, to be forcibly suspended and another process 412-m having the remaining amount of the executable time to use the CPU core 331-j. At this time, by selecting the process 412-m based on the remaining amount of the executable time, for example, the process 412-m with a large remaining amount of the executable time may be preferentially caused to use the CPU core 331-j.

Furthermore, when the interrupt signal is output from the PMU 332-j, the control unit 1011 switches the process 412-k in the CPU core 331-j to another process 412-m.

At this time, the control unit 1011 changes the remaining amounts of the executable time and consumable energy of the process 412-k recorded in the management table 921 to zero. Next, the control unit 1011 selects the process 412-m based on the remaining amount of the executable time of each of the processes 412-1 to 412-P. Then, the control unit 1011 stops the operation of the process 412-k and allocates the process 412-m to the CPU core 331-j to operate the process 412-m in the CPU core 331-j.

This allows the processing of the process 412-k, which has run out of the remaining amount of the consumable energy, to be forcibly suspended and another process 412-m having the remaining amount of the executable time to use the CPU core 331-j. At this time, by selecting the process 412-m based on the remaining amount of the executable time, for example, the process 412-m with a large remaining amount of the executable time may be preferentially caused to use the CPU core 331-j.

When any process 412-k temporarily terminates processing due to abandoned processing, the control unit 1011 acquires CTR of the process 412-k from the PMU 332-j in the CPU core 331-j in which the process 412-k is operating.

The control unit 1011 calculates ES by formula (2) and changes the current energy slice value of the process 412-k recorded in the management table 921 to ES to reduce the current energy slice value.

Next, the control unit 1011 subtracts the time consumption from the remaining amount of the executable time of the process 412-k recorded in the management table 921 and checks whether or not the remaining amount of the executable time coincides with zero. The time consumption represents time used by the process 412-k until the time point of switching. The time consumption may have a fixed value. When the remaining amount of the executable time coincides with zero, the control unit 1011 changes the remaining amount of the consumable energy of the process 412-k recorded in the management table 921 to zero.

Next, the control unit 1011 switches the process 412-k in the CPU core 331-j to another process 412-m.

At this time, the control unit 1011 selects the process 412-m based on the remaining amount of the executable time of each of the processes 412-1 to 412-P. Then, the control unit 1011 stops the operation of the process 412-k and allocates the process 412-m to the CPU core 331-j to operate the process 412-m in the CPU core 331-j.

This allows the process 412-k, which no longer needs to continue processing, to be stopped and another process 412-m having the remaining amount of the executable time to use the CPU core 331-j. At this time, by selecting the process 412-m based on the remaining amount of the executable time, for example, the process 412-m with a large remaining amount of the executable time may be preferentially caused to use the CPU core 331-j.

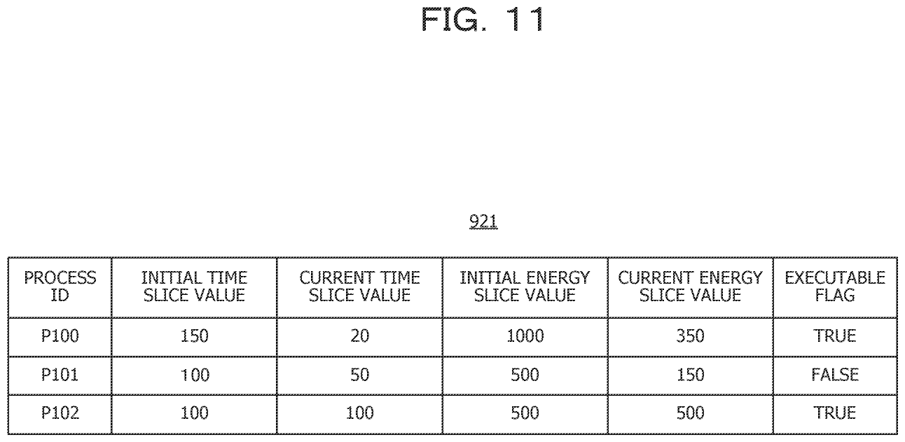

FIG. 11 illustrates an example of the management table 921 in FIG. 9. The management table 921 in FIG. 11 contains a process ID, an initial time slice value, a current time slice value, an initial energy slice value, a current energy slice value, and an executable flag.

The process ID, the initial energy slice value, the current energy slice value, and the executable flag are similar to the case in FIG. 5. The initial time slice value represents executable time allocated to the process 412-k, and the current time slice value represents the remaining amount of the executable time. The units of the initial time slice value and the current time slice value are milliseconds (ms).

For example, the process P100 has an initial time slice value of 150 ms and a current time slice value of 20 ms. In this case, 130 ms, which is the difference between the initial time slice value and the current time slice value, has already been used by the process P100.

Each time the process 412-k is generated, the control unit 1011 adds an entry of the generated process 412-k to the management table 921 and deletes the added entry when the process 412-k disappears.

When the process 412-k is generated, the control unit 1011 sets the executable time as the initial time slice value and the current time slice value and sets the consumable energy as the initial energy slice value and the current energy slice value. Then, the control unit 1011 sets the executable flag to TRUE.

When allocating the process 412-k whose executable flag is TRUE to one CPU core 331-j, the control unit 1011 instruct the timer 911 to start counting and output the interrupt signal at regular time intervals.

Additionally, the control unit 1011 sets CTR0 in formula (1) in CTR of the PMU 332-j in the one CPU core 331-j and instructs the PMU 332-j to start counting. The PMU 332-j starts counting from CTR0 and increments CTR by one each time the CPU core 331-j consumes one unit of energy consumption. Then, when a counter overflow occurs, the PMU 332-j outputs the interrupt signal to the control unit 1011.

Each time the interrupt signal is output from the timer 911, the control unit 1011 subtracts a certain amount of time from the current time slice value of the process 412-k recorded in the management table 921. When the current time slice value coincides with 0 ms, the control unit 1011 selects the process 412-m having the maximum current time slice value from among the processes 412-k whose executable flag is TRUE. Then, the control unit 1011 switches the process 412-k that has run out of the current time slice value to the selected process 412-m.

Note that the current time slice values of all processes 412-k whose executable flag is TRUE may be 0 ms. In this case, the control unit 1011 changes the current time slice value to the initial time slice value and changes the current energy slice value to the initial energy slice value for these processes 412-k. Then, the control unit 1011 selects the process 412-m having the maximum current time slice value from among these processes 412-k.

When the interrupt signal is output from the PMU 332-j, the control unit 1011 changes the current time slice value of the process 412-k recorded in the management table 921 to 0 ms and changes the current energy slice value to 0 nJ. Next, the control unit 1011 selects the process 412-m having the maximum current time slice value from among the processes 412-k whose executable flag is TRUE. Then, the control unit 1011 switches the process 412-k that has run out of the current energy slice value to the selected process 412-m.

By changing the current time slice value of the process 412-k to 0 ms, this process 412-k may be restricted from being selected as the process 412-m.

Note that the current time slice values of all processes 412-k whose executable flag is TRUE may be 0 ms. In this case, the control unit 1011 changes the current time slice value to the initial time slice value and changes the current energy slice value to the initial energy slice value for these processes 412-k. Then, the control unit 1011 selects the process 412-m having the maximum current time slice value from among these processes 412-k.

When the process 412-k is switched to another process due to abandoned processing before the process 412-k runs out of the current time slice value or current energy slice value, the control unit 1011 acquires CTR of the process 412-k from the PMU 332-j. Then, the control unit 1011 calculates ES by formula (2) and changes the current energy slice value of the process 412-k recorded in the management table 921 to ES.

Next, the control unit 1011 subtracts the time consumption from the remaining amount of the executable time of the process 412-k recorded in the management table 921. When the remaining amount of the executable time coincides with zero, the control unit 1011 changes the current energy slice value of the process 412-k recorded in the management table 921 to 0 nJ.

The control unit 1011 changes the executable flag of the process 412-k recorded in the management table 921 from TRUE to FALSE. Then, the control unit 1011 selects another process 412-m in a manner similar to when the interrupt signal is output and switches the process 412-k in which abandoned processing has occurred to the process 412-m.

Thereafter, when it is detected that the state of the process 412-k has shifted to the executable state, the control unit 1011 changes the executable flag of this process 412-k from FALSE to TRUE.

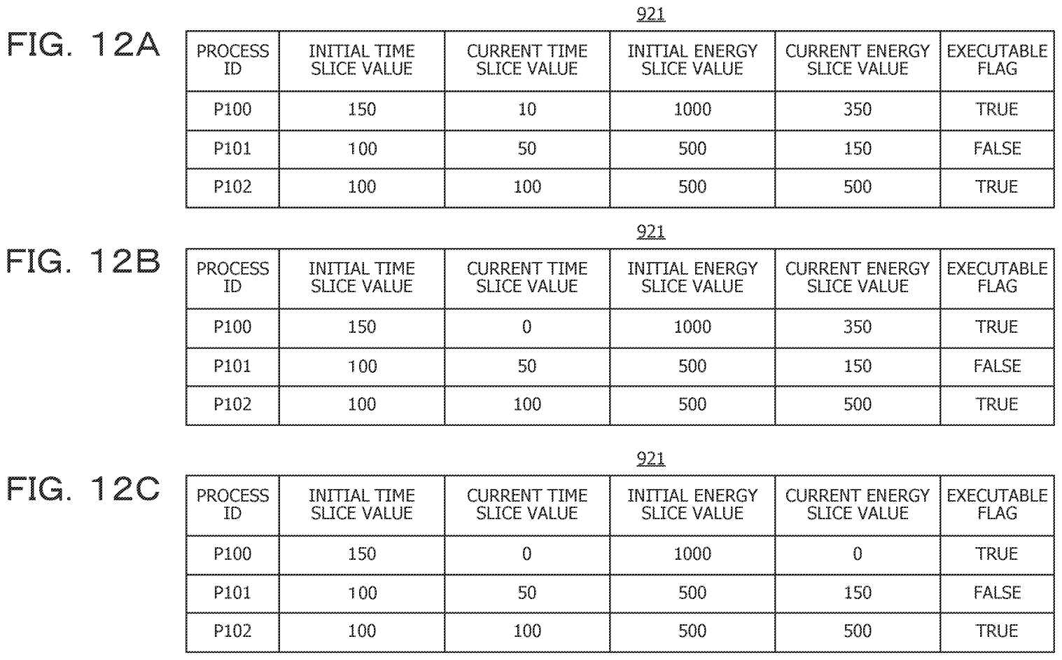

FIGS. 12A to 12C illustrate examples of third update processing that updates the management table 921 when the interrupt signal is output from the timer 911. In this example, 10 ms is used as the certain amount of time.

FIG. 12A illustrates an example of update processing when the interrupt signal is output from the timer 911 while the process P100 in FIG. 11 is operating in the CPU core 331-1. In this case, 10 ms is subtracted from 20 ms, which is the current time slice value of the process P100, and the current time slice value is changed to 10 ms. However, since the current time slice value does not coincide with 0 ms, the process P100 continues to operate.

FIG. 12B illustrates an example of update processing when the next interrupt signal is output from the timer 911 in the state of FIG. 12A. In this case, 10 ms is subtracted from 10 ms, which is the current time slice value of the process P100, and the current time slice value is changed to 0 ms.

FIG. 12C illustrates an example of update processing that updates the current energy slice value of the process P100 in FIG. 12B. Since the current time slice value of process P100 has coincided with 0 ms, the current energy slice value is changed to 0 ms. Then, among the processes P100 and P102 whose executable flag is TRUE, the process P102 having the maximum current time slice value is selected, and the process P100 is switched to the process P102.

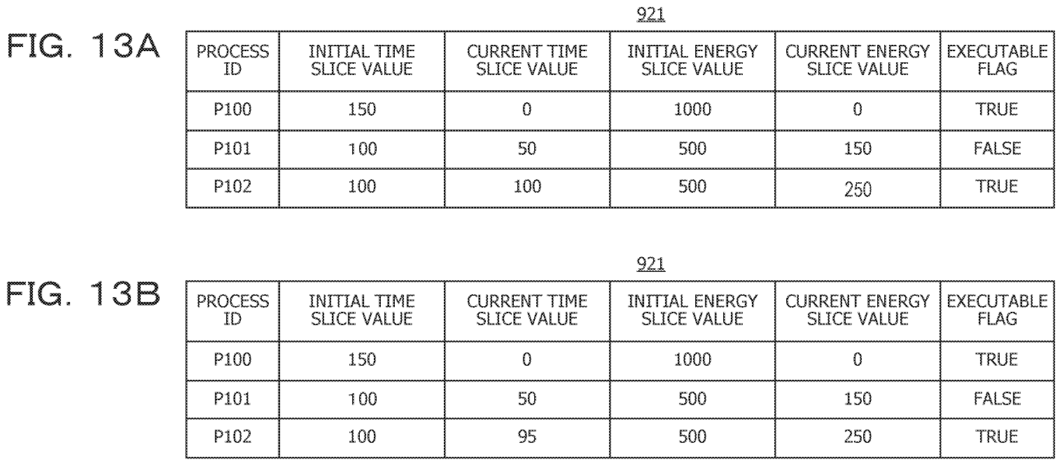

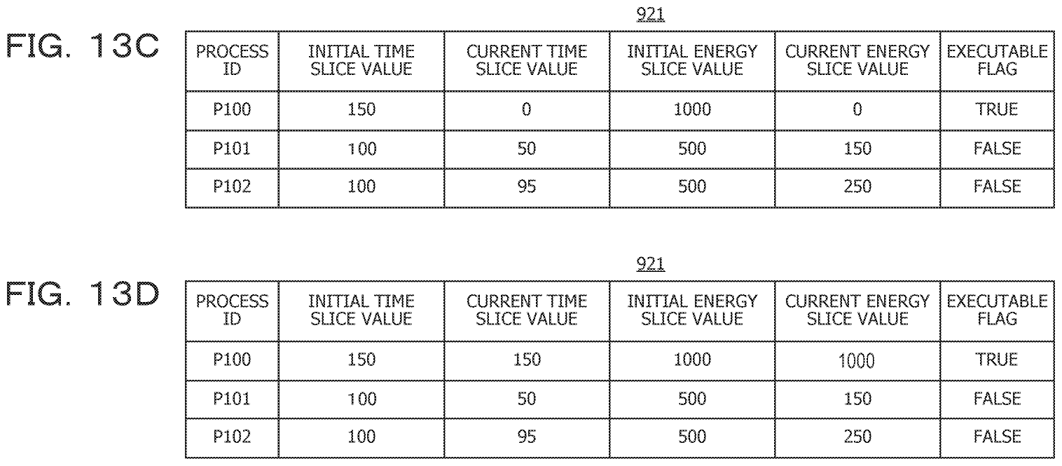

FIGS. 13A to 13D illustrate examples of fourth update processing that updates the management table 921 when abandoned processing occurs in the process 412-k. In this example, 5 ms is used as the time consumption.

FIG. 13A illustrates an example of update processing when abandoned processing occurs in the process P102 while the process P102 in FIG. 12C is operating in the CPU core 331-1. In this case, the current energy slice value of the process P102 is updated by formula (2).

For example, in a case where the process P102 has consumed 250 nJ out of 500 nJ and CTR=CTR0+250 holds when abandoned processing occurs, the updated current energy slice value is calculated by the following formula (4).

$$\begin{matrix}ES = CTRMAX - ( CTR 0 + 250 ) + 1 \\ = CTRMAX - ( CTRMAX - 500 + 1 + 250 ) + 1 \\ = 250\end{matrix} \qquad ( 4 )$$

FIG. 13B illustrates an example of update processing that updates the current time slice value of the process P102 in FIG. 13A. Since 5 ms is subtracted from 100 ms, which is the current time slice value of the process P102, the current time slice value is changed to 95 ms. However, the current time slice value does not coincide with 0 ms, and accordingly the current energy slice value is not changed.

FIG. 13C illustrates an example of update processing that updates the executable flag of the process P102 in FIG. 13B. When abandoned processing occurs in the process P102, the executable flag of the process P102 is changed from TRUE to FALSE.

FIG. 13D illustrates an example of update processing that updates the current time slice value and the current energy slice value of the process P102 in FIG. 13C. In FIG. 13C, only the executable flag of the process P100 is TRUE, and the current time slice value of the process P100 is 0 ms.

Therefore, the current time slice value of the process P100 is changed to 150 ms, which is the initial time slice value, and the current energy slice value is changed to 1000 nJ, which is the initial energy slice value. Then, the process P100 having the maximum current time slice value is selected, and the process P102 is switched to the process P100.

According to the computer 901 in FIG. 9, the consumable energy is allocated to each process 412-k, and the process 412-k that has run out of the remaining amount of the consumable energy is switched to another process 412-m. This enables scheduling based on the energy consumption of the processes 412-k.

By setting, as the consumable energy, a value that increases as the process 412-k has a higher priority, the process 412-k with a higher priority may be preferentially caused to consume the power. This allows the power consumption of each CPU core 331-j to be flexibly controlled.

The computer 901 sometimes includes the multi-core and multi-socket CPU 321-i and executes a plurality of processes 412-k in parallel at different operating frequencies. Even in such a case, by providing the PMU 332-j in each CPU core 331-j, the energy consumption of each process 412-k may be measured accurately.

Additionally, by using time-division and preemptive multitasking scheduling in combination, even when the process 412-k has run out of the remaining amount of the executable time, this process 412-k may be switched to another process 412-m.

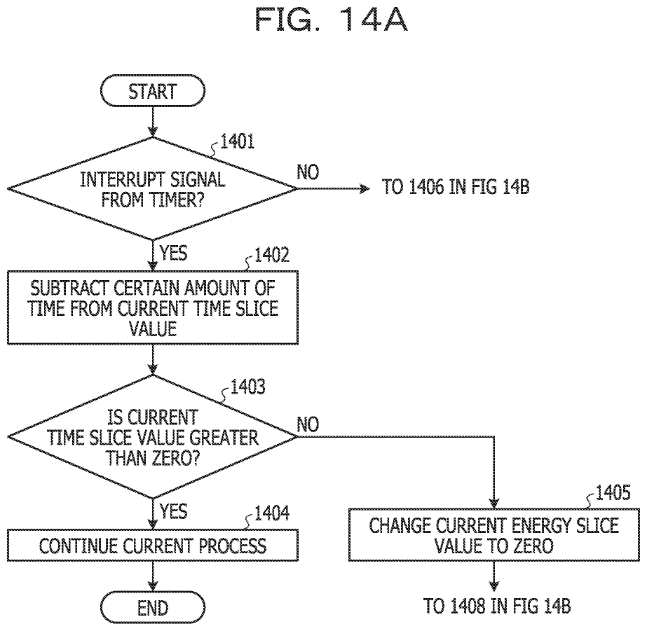

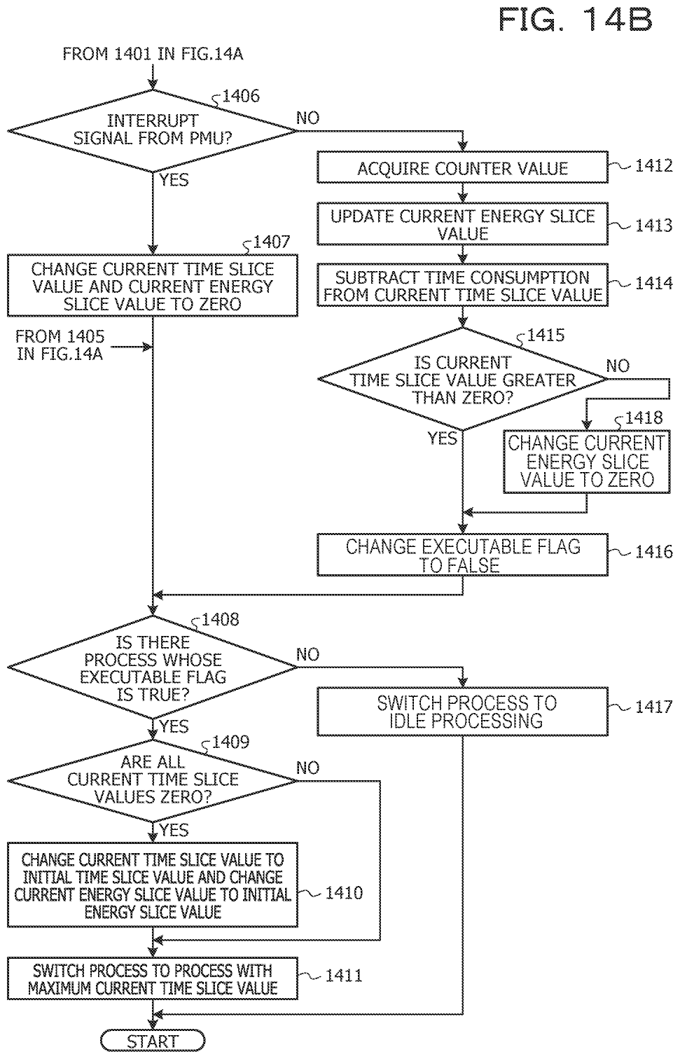

FIGS. 14A and 14B are flowcharts illustrating an example of second scheduling processing performed by the computer 901 in FIG. 9. This scheduling processing is performed when the interrupt signal from the timer 911 or the PMU 332-j, or abandoned processing occurs while any process 412-k is operating in any CPU core 331-j of any CPU 321-i.

First, the control unit 1011 checks whether or not the interrupt signal from the timer 911 has occurred (step 1401).

When the interrupt signal from the timer 911 has occurred (step 1401, YES), the control unit 1011 subtracts a certain amount of time from the current time slice value of the process 412-k recorded in the management table 921 (step 1402). Then, the control unit 1011 updates the current time slice value by changing the current time slice value of the process 412-k to the value after the subtraction. When the value after the subtraction has a negative value, the current time slice value is changed to zero.

Next, the control unit 1011 checks whether or not the current time slice value of the process 412-k is greater than zero (step 1403). When the current time slice value of the process 412-k is greater than zero (step 1403, YES), the control unit 1011 continues to operate the current process 412-k (step 1404).

On the other hand, when the current time slice value of the process 412-k is zero (step 1403, NO), the control unit 1011 changes the current energy slice value of the process 412-k recorded in the management table 921 to zero (step 1405).

Next, the control unit 1011 checks whether or not there is the process 412-k whose executable flag is TRUE in the management table 921 (step 1408). When there is the process 412-k whose executable flag is TRUE (step 1408, YES), the control unit 1011 checks the current time slice value of each process 412-k whose executable flag is TRUE (step 1409).

When the current time slice values of all processes 412-k whose executable flag is TRUE are zero (step 1409, YES), the control unit 1011 performs the processing in step 1410. The control unit 1011 changes the current time slice value of each process 412-k whose executable flag is TRUE to the particular initial time slice value of each process 412-k (step 1410). Additionally, the control unit 1011 changes the current energy slice value of each process 412-k whose executable flag is TRUE to the particular initial energy slice value of each process 412-k (step 1410).

Then, the control unit 1011 selects the process 412-m having the maximum current time slice value from among the processes 412-k whose executable flag is TRUE and switches the process 412-k that has been operating to the process 412-m (step 1411).

When the current time slice value of any process 412-k whose executable flag is TRUE is not zero (step 1409, NO), the control unit 1011 performs the processing in step 1411.

When there is no process 412-k whose executable flag is TRUE in the management table 921 (step 1408, NO), the control unit 1011 switches the process 412-k that has been operating to idle processing (step 1417).

When the interrupt signal from the timer 911 has not occurred (step 1401, NO), the control unit 1011 checks whether or not the interrupt signal from the PMU 332-j has occurred (step 1406).

When the interrupt signal from the PMU 332-j has occurred (step 1406, YES), the control unit 1011 changes the current time slice value and the current energy slice value of the process 412-k recorded in the management table 921 to zero (step 1407). Then, the control unit 1011 performs the processing in step 1408 and subsequent steps.

When abandoned processing has occurred in the process 412-k (step 1406, NO), the control unit 1011 acquires the counter value CTR of the process 412-k from the PMU 332-j in the CPU core 331-j in which the process 412-k is operating (step 1412).

Next, the control unit 1011 calculates ES by formula (2) and changes the current energy slice value of the process 412-k recorded in the management table 921 to ES to update the current energy slice value (step 1413).

Next, the control unit 1011 subtracts the time consumption from the current time slice value of the process 412-k recorded in the management table 921 (step 1414). Then, the control unit 1011 updates the current time slice value by changing the current time slice value of the process 412-k to the value after the subtraction. When the value after the subtraction has a negative value, the current time slice value is changed to zero.

Next, the control unit 1011 checks whether or not the current time slice value of the process 412-k is greater than zero (step 1415). When the current time slice value of the process 412-k is greater than zero (step 1415, YES), the control unit 1011 changes the executable flag of the process 412-k recorded in the management table 921 from TRUE to FALSE (step 1416). Then, the control unit 1011 performs the processing in step 1408 and subsequent steps.

On the other hand, when the current time slice value of the process 412-k is zero (step 1415, NO), the control unit 1011 changes the current energy slice value of the process 412-k recorded in the management table 921 to zero (step 1418). Then, the control unit 1011 performs the processing in step 1416 and subsequent steps.

The configurations of the computer 101 in FIG. 1, the computer 301 in FIG. 3, and the computer 901 in FIG. 9 are merely examples, and some components may be omitted or changed depending on the use or conditions of the computers. The configurations of the arithmetic processing units 311 in FIGS. 4 and 10 are merely examples, and some components may be omitted or changed depending on the use or conditions of the computers. Instead of the process 412-k, a job, a task, a thread, and the like may be used as the unit of processing.

The flowcharts in FIGS. 2, 14A, and 14B are merely examples, and some pieces of processing may be omitted or changed depending on the configuration or conditions of the computers.

The management table 341 illustrated in FIGS. 5 to 7B and the management table 921 illustrated in FIGS. 11 to 13D are merely examples, and the management tables 341 and 921 vary depending on the processes generated in the arithmetic processing units 311.

Formulas (1) to (4) are merely examples, and the computers 301 and 901 may perform the scheduling processing using other calculation formulas.

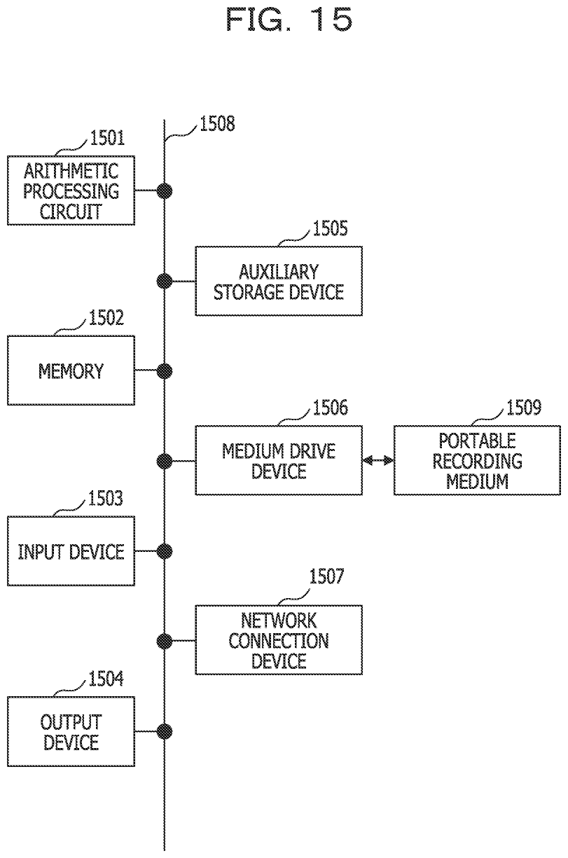

FIG. 15 illustrates an exemplary hardware configuration of an information processing device to be used as the computer 101 in FIG. 1, the computer 301 in FIG. 3, and the computer 901 in FIG. 9. The information processing device in FIG. 15 includes an arithmetic processing circuit 1501, a memory 1502, an input device 1503, an output device 1504, an auxiliary storage device 1505, a medium drive device 1506, and a network connection device 1507. These components are hardware and are connected to each other by a bus 1508.

The memory 1502 is, for example, a semiconductor memory such as a read only memory (ROM) or a random access memory (RAM) and stores programs and data to be used for processing. The memory 1502 may operate as the storage unit 312 in FIG. 3 or 8.

The arithmetic processing circuit 1501 operates as the arithmetic processing units 311 in FIGS. 3 and 9. The arithmetic processing circuit 1501 also operates as the control unit 411 in FIG. 4 or the control unit 1011 in FIG. 10, for example, by executing a program using the memory 1502. The timer 911 in FIG. 9 may be connected to the arithmetic processing circuit 1501.

For example, the input device 1503 is a keyboard, a pointing device, or the like and is used for inputting an instruction or information from an operator or a user. For example, the output device 1504 is a display device, a printer, or the like and is used for an inquiry or an instruction to the operator or the user, and outputting a processing result.

For example, the auxiliary storage device 1505 is a magnetic disk device, an optical disk device, a magneto-optical disk device, a tape device, or the like. The auxiliary storage device 1505 may be a hard disk drive. The information processing device may store programs and data in the auxiliary storage device 1505 and load these programs and data into the memory 1502 to use.

The medium drive device 1506 drives a portable recording medium 1509 and accesses recorded contents of the portable recording medium 1509. The portable recording medium 1509 is a memory device, a flexible disk, an optical disk, a magneto-optical disk, or the like.

The portable recording medium 1509 may be a compact disk read only memory (CD-ROM), a digital versatile disk (DVD), a universal serial bus (USB) memory, or the like. The operator or the user may store programs and data in the portable recording medium 1509 and load these programs and data into the memory 1502 to use.

As described above, a computer-readable recording medium in which the programs and data used for processing are stored is a physical (non-transitory) recording medium such as the memory 1502, the auxiliary storage device 1505, or the portable recording medium 1509.

The network connection device 1507 is a communication interface circuit that is connected to a communication network such as a local area network (LAN) and a wide area network (WAN), and that performs data conversion pertaining to communication. The information processing device may receive programs and data from an external device via the network connection device 1507 and load these programs and data into the memory 1502 to use.

Note that the information processing device does not need to include all the components in FIG. 15, and some components may be omitted depending on the use or conditions of the information processing device. For example, in a case where an interface with the operator or the user is not needed, the input device 1503 and the output device 1504 may be omitted. In a case where the portable recording medium 1509 or the communication network is not used, the medium drive device 1506 or the network connection device 1507 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device, comprising:
a memory; and
a processor coupled to the memory and the processor configured to:
measure energy consumption of a first unit of processing that operates in the processor;
stop an operation of the first unit of processing when the measured energy consumption reaches a predetermined value; and
operate a second unit of processing in the processor.

2. The information processing device according to claim 1, wherein
the memory stores a remaining amount of consumable energy allocated to each of a plurality of units of processing generated in the processor, the plurality of units of processing including the first unit of processing and the second unit of processing, and
the processor is further configured to:
select any of the plurality of units of processing other than the first unit of processing as the second unit of processing, based on the remaining amount of the consumable energy of each of the plurality of units of processing.

3. The information processing device according to claim 2, wherein
the processor is further configured to:
when the measured energy consumption reaches the predetermined value, output interrupt information that indicates that the energy consumption has reached the predetermined value, by using the remaining amount of the consumable energy of the first unit of processing as the predetermined value;
upon outputting the interrupt information, change the remaining amount of the consumable energy of the first unit of processing stored in the memory to zero; and
select one of the plurality of units of processing with a maximum remaining amount of the consumable energy, as the second unit of processing.

4. The information processing device according to claim 2, wherein
the processor is further configured to:
measure the energy consumption of the second unit of processing when the second unit of processing operates in the processor;
when the second unit of processing temporarily terminates processing, acquire information regarding the energy consumption of the second unit of processing;
reduce the remaining amount of the consumable energy of the second unit of processing stored in the memory, based on the information regarding the energy consumption of the second unit of processing;
stop the operation of the second unit of processing; and
operate any of the plurality of units of processing other than the second unit of processing in the processor.

5. The information processing device according to claim 2, wherein
the memory further stores a remaining amount of executable time that is allocated to each of the plurality of units of processing, and
the processor is further configured to:
select any of the plurality of units of processing other than the first unit of processing as the second unit of processing, based on the remaining amount of the executable time of each of the plurality of units of processing.

6. The information processing device according to claim 5, wherein
the processor is further configured to:
when the measured energy consumption reaches the predetermined value, output interrupt information that indicates that the energy consumption has reached the predetermined value, by using the remaining amount of the consumable energy of the first unit of processing as the predetermined value;
upon outputting the interrupt information, change the remaining amount of the executable time of the first unit of processing stored in the memory to zero; and
select one of the plurality of units of processing with a maximum remaining amount of the executable time, as the second unit of processing.

7. The information processing device according to claim 5, wherein
the processor is further configured to:
measure the energy consumption of the second unit of processing when the second unit of processing operates in the processor;
when the second unit of processing temporarily terminates processing, acquire information regarding the energy consumption of the second unit of processing;
reduce the remaining amount of the consumable energy of the second unit of processing stored in the memory, based on the information regarding the energy consumption of the second unit of processing;
reduce the remaining amount of the executable time of the second unit of processing stored in the memory;
stop the operation of the second unit of processing; and
operate any of the units of processing other than the second unit of processing in the processor.

8. A method of scheduling, the method comprising:
measuring, by a computer, energy consumption of a first unit of processing that operates in a processor of the computer;
stopping an operation of the first unit of processing when the measured energy consumption reaches a predetermined value; and
operating a second unit of processing in the processor.

9. The method according to claim 8, wherein
a memory of the computer stores a remaining amount of consumable energy allocated to each of a plurality of units of processing generated in the processor, the plurality of units of processing including the first unit of processing and the second unit of processing, and
the method further comprises:
selecting any of the plurality of units of processing other than the first unit of processing as the second unit of processing, based on the remaining amount of the consumable energy of each of the plurality of units of processing.

10. The method according to claim 9, the method further comprising:
when the measured energy consumption reaches the predetermined value, outputting interrupt information that indicates that the energy consumption has reached the predetermined value, by using the remaining amount of the consumable energy of the first unit of processing as the predetermined value;
upon outputting the interrupt information, changing the remaining amount of the consumable energy of the first unit of processing stored in the memory to zero; and
selecting one of the plurality of units of processing with a maximum remaining amount of the consumable energy, as the second unit of processing.

11. The method according to claim 9, wherein
the memory further stores a remaining amount of executable time that is allocated to each of the plurality of units of processing, and
the method further comprises:
selecting any of the plurality of units of processing other than the first unit of processing as the second unit of processing, based on the remaining amount of the executable time of each of the plurality of units of processing.

12. The method according to claim 11, the method further comprising:
when the measured energy consumption reaches the predetermined value, outputting interrupt information that indicates that the energy consumption has reached the predetermined value, by using the remaining amount of the consumable energy of the first unit of processing as the predetermined value;
upon outputting the interrupt information, changing the remaining amount of the executable time of the first unit of processing stored in the memory to zero; and
selecting one of the plurality of units of processing with a maximum remaining amount of the executable time, as the second unit of processing.

13. A non-transitory computer-readable recording medium having stored therein a program that causes a computer to execute a process, the process comprising:
measuring energy consumption of a first unit of processing that operates in a processor of the computer;
stopping an operation of the first unit of processing when the measured energy consumption reaches a predetermined value; and
operating a second unit of processing in the processor.

14. The non-transitory computer-readable recording medium according to claim 13, wherein
a memory of the computer stores a remaining amount of consumable energy allocated to each of a plurality of units of processing generated in the processor, the plurality of units of processing including the first unit of processing and the second unit of processing, and
the process further comprises:
selecting any of the plurality of units of processing other than the first unit of processing as the second unit of processing, based on the remaining amount of the consumable energy of each of the plurality of units of processing.

15. The non-transitory computer-readable recording medium according to claim 14, the process further comprising:
when the measured energy consumption reaches the predetermined value, outputting interrupt information that indicates that the energy consumption has reached the predetermined value, by using the remaining amount of the consumable energy of the first unit of processing as the predetermined value;
upon outputting the interrupt information, changing the remaining amount of the consumable energy of the first unit of processing stored in the memory to zero; and
selecting one of the plurality of units of processing with a maximum remaining amount of the consumable energy, as the second unit of processing.

16. The non-transitory computer-readable recording medium according to claim 14, wherein
the memory further stores a remaining amount of executable time that is allocated to each of the plurality of units of processing, and
the process further comprises:
selecting any of the plurality of units of processing other than the first unit of processing as the second unit of processing, based on the remaining amount of the executable time of each of the plurality of units of processing.

17. The non-transitory computer-readable recording medium according to claim 16, the process further comprising:
when the measured energy consumption reaches the predetermined value, outputting interrupt information that indicates that the energy consumption has reached the predetermined value, by using the remaining amount of the consumable energy of the first unit of processing as the predetermined value;
upon outputting the interrupt information, changing the remaining amount of the executable time of the first unit of processing stored in the memory to zero; and
selecting one of the plurality of units of processing with a maximum remaining amount of the executable time, as the second unit of processing.
